(19) United States
(12) Patent Application Publication
(10) Pub. No.: US 2020/0383190 A1
(43) Pub. Date: Dec. 3, 2020

(54) METHOD FOR CONTROLLING A LIGHTING SYSTEM USING A LIGHTING CONTROL CONSOLE

(71) Applicant: MA LIGHTING TECHNOLOGY GMBH, Waldbuttelbrunn (DE)

(72) Inventor: Michael Adenau, Würzburg (DE)

(21) Appl. No.: 16/099,030

(22) PCT Filed: Nov. 9, 2017
(86) PCT No.: PCT/EP2017/078712

§ 371 Date: Nov. 5, 2018

(51) Int. Cl. H05B 47/12; H05B 47/18

(52) U.S. Cl. CPC H05B 47/12; G10L 25/51; H05B 47/18

(57) ABSTRACT

The invention relates to a method for controlling a lighting system using a lighting control console, wherein digital adjusting commands are generated in the lighting control console, which commands can be transmitted to a lighting device of the lighting system via data links, wherein one light effect can in each case be generated by actuating the lighting devices, and wherein at least one adjustable lighting device can be adjusted using at least one actuator in order to be able to move towards the different positions of the lighting device, having the following method steps,
a) switching off the adjustable lighting device under program control such that the lighting device generates no light effect;
b) driving the actuator, under program control, for moving towards the next predefined position of the lighting device;
c) switching on the lighting device, under program control, for generating a light effect in the position to which it has been moved; wherein the ambient noise level is measured using a microphone, the lighting device being adjusted by driving it using the assigned actuator as a function of the measured ambient noise level.

The invention relates to a method for controlling a lighting system using a lighting control console, according to the preamble of claim 1.

Lighting control consoles serve for controlling lighting systems such as those employed in theaters or at concerts, for instance. Routinely, said lighting systems comprise a plurality of lighting devices, for instance stage spotlights, wherein, in the lighting devices on their own, it is in many cases also possible to switch between a plurality of lighting states, for instance between different colors. These different lighting states are controlled in the lighting program of the lighting control console by way of programmed parameters. Here, standard lighting systems may comprise up to several thousand lighting devices.

With each lighting device, at least one light effect, for instance a beam of light, can be generated in order to light the stage with these light effects, which in many cases overlap. The generic method here relates to controlling lighting devices that can be adjusted with at least one actuator in order to be able to move towards different positions of the lighting device. If said lighting device is, for instance, a stage spotlight, the beam of light of the spotlight can be pivoted freely across the stage by moving the corresponding actuators in two axes in order to follow, for instance, the main protagonist.

From the state of the art, a lighting method is known that is referred to as “Move in Black”. The aim of this “Move in Black” method is to completely switch off the corresponding light effect of the lighting device before moving towards a new position of the lighting device in order to avoid that the audience perceives the movement of the spotlight as a moving light effect while the next position is approached. The “Move in Black” control concept is here substantially based on three steps. In the first step, the lighting device is initially switched off under program control so that the lighting device generates no light effects anymore. After the lighting device has completely gone out, the actuator is activated, either immediately or after a certain delay, by the lighting control console under program control in order to move towards the next predefined position of the lighting device using the actuators. In the third step, the lighting device is then switched on again after the predefined position has been reached in order to generate a light effect. The lighting device can, as a matter of course, also be switched on or off in the manner of a dimming process, during which the luminosity of the lighting device is regulated up or down along a dimming curve.

By means of the “Move in Black” method, undesired optical effects that occur when a lighting device is moved while the light source remains switched on are avoided. However, even with the “Move in Black” method, other undesired disturbances of the stage show can arise, namely owing to undesired acoustical interferences. This is because, depending on the type of the respective lighting device, considerable engine noise can arise due to the driving of the actuators, which noise acoustically impacts the stage show when the ambient noise level is correspondingly low. If, for instance on a theater stage, an actor delivers a monologue in a certain scene, there is almost no noise in the auditorium at this time.

If, during such a monologue scene, a stage spotlight was then moved to the next predefined lighting position in advance, the audience would perceive this as a considerable acoustical interference.

It is therefore the object of the present invention to propose an enhanced “Move in Black” method with which acoustical interferences due to the lighting devices being moved can be avoided.

This object is attained by a method according to the teachings of claim 1.

Advantageous embodiments of the invention are the subject-matter of the dependent claims.

The inventive method is based on the idea of measuring the ambient noise level with a microphone at a suitable location, for instance in the center of the auditorium. For instance, the microphone can be installed in the lighting control console itself or can be connected to the lighting control console via a corresponding cable. By performing the measurement using the microphone, it can be determined by a physical measuring if the ambient noise level is high enough to cover the movement sounds of the actuators without any problem or if it is so quiet on the stage or in the auditorium that there would be a relevant acoustical interference if the actuators were moved. Depending on this evaluation, that means as a function of the ambient noise level that has been measured, the lighting device is then moved using the actuators.

In which way the movement of the lighting device depends on the respective ambient noise level that has been measured is basically arbitrary. In accordance with a preferred embodiment, it is envisaged that the adjustment of the lighting device by driving it with the assigned actuator is only started after the measured ambient noise level has exceeded a predetermined noise threshold. In this way, it can in particular be avoided that the actuators are switched on for moving the lighting device towards its next position when it would be sensed as an interference due to the very low ambient noise level. As soon as the ambient noise level has then exceeded the predetermined noise threshold, for instance because of the applause of the audience, the actuators can then be adjusted by being moved without any problem.

If the actuators are activated as a function of the ambient noise level that has been measured, in particular if the actuators are only started after the measured ambient noise level has exceeded a predetermined noise threshold, this can result in the problem that the ambient noise level exceeds the corresponding threshold at no time and that the lighting device can therefore not be moved towards its next predefined position. In this case, the lighting program would not be able to fulfill its intended purpose anymore since the desired lighting effect cannot be achieved because there was no prepositioning. In order to preclude this in any case, it is envisaged in accordance with a preferred embodiment that the adjustment of the lighting device by driving it with the assigned actuator is started, irrespective of the measured ambient noise level, at a point of time lying ahead, by the travel time that is needed for moving towards the next position, of the point of time of the next switching-on of the lighting device under program control. In other words, this means that the actuators are switched on at the latest when there is still enough time for moving towards the next predefined position, even if the predetermined noise threshold has not been exceeded by then. In this way, it is in any case guaranteed that the program controlled light effects are adhered to and a small acoustical disturbance may be tolerated.

When corresponding lighting programs are run under program control, the lighting devices are switched off or on under program control. In this case, the light scenes are predefined in individual lighting steps, which run one after the other. In order to give the user of the lighting control console the opportunity to imperatively preclude an adjustment of the lighting device for individual program steps, the corresponding program steps can be marked in the program sequence in such a manner that the adjustment of the lighting device by moving it using the assigned actuator is precluded in these program steps, irrespective of the ambient noise level that has been measured.

1. A method for controlling a lighting system using a lighting control console, wherein digital adjusting commands are generated in the lighting control console, which commands are transmitted to a lighting device of the lighting system via data links, wherein one light effect can in each case be generated by actuating the lighting devices, and wherein at least one adjustable lighting device can be adjusted using at least one actuator in order to be able to move towards the different positions of the lighting device,
having the following method steps,
a) switching off the adjustable lighting device under program control such that the lighting device generates no light effect;
b) driving the actuator, under program control, for moving towards the next predefined position of the lighting device;
c) switching on the lighting device, under program control, for generating a light effect in the position to which it has been moved;
wherein
the ambient noise level is measured using a microphone, the lighting device being adjusted by driving it with the assigned actuator as a function of the measured ambient noise level.

2. The method according to claim 1,
wherein
the adjustment of the lighting device by driving it using the assigned actuator is only started after the measured ambient noise level has exceeded a predetermined noise threshold.

3. The method according to claim 1,
wherein
the adjustment of the lighting device by driving it using the assigned actuator is started, irrespective of the measured ambient noise level, at a point of time lying ahead, by the travel time that is needed for moving towards the next position, of the point of time of the next switching-on of the lighting device under program control.

4. The method according to claim 1,
wherein
multiple program steps of a lighting program are run between the lighting device being switched off under program control and the lighting device being switched on under program control, an adjustment of the lighting device by driving it using the assigned actuator irrespective of the measured ambient noise level being precluded for at least one program step under program control.
